(19) United States
(12) Patent Application Publication
(10) Pub. No.: US 2017/0348620 A1
(43) Pub. Date: Dec. 7, 2017

(54) Modular Contaminant Filtering System For Rain Water Run-Off, Emergency Spills, and Isolated Regular Discharge Flows

(71) Applicant: Jahangir S. Rastegar, Stony Brook, NY (US)

(72) Inventor: Jahangir S. Rastegar, Stony Brook, NY (US)

(73) Assignee: Omnitek Partners LLC, Ronkonkoma, NY (US)

(21) Appl. No.: 15/610,555

(22) Filed: May 31, 2017

Related U.S. Application Data
(60) Provisional application No. 62/344,356, filed on Jun. 1, 2016.

(51) Int. Cl. B01D 29/96; B01D 29/52; E03F 5/04; B01D 29/58; B01D 35/02; B01D 35/143; B01D 35/34; B01D 61/00; B01D 65/00; C02F 1/44; C02F 1/00; E03F 5/06; C02F 101/20; C02F 101/32; C02F 103/00; C02F 103/32; C02F 103/44

(52) U.S. Cl. CPC B01D 29/96; E03F 5/06; B01D 29/52; E03F 5/0404; B01D 29/58; B01D 35/02; B01D 35/1435; B01D 35/34; B01D 61/00; B01D 65/00; C02F 1/44; C02F 1/001; B01D 2317/04; B01D 2319/025; C02F 2101/20; C02F 2101/32; C02F 2103/001; C02F 2103/32; C02F 2103/44

(57) ABSTRACT

A method for filtering one or more of run-off fluid, chemical spills and facility discharge, the method including: storing a first portion of the one or more of run-off fluid, chemical spills and facility discharge in a first compartment; discharging additional fluid from an overflow in the first compartment when a volume capacity of the first compartment is full; in a second compartment in fluid communication with the first compartment, filtering the one or more of run-off fluid, chemical spills and facility discharge stored in the first compartment that is not discharged through the overflow, and discharging filtered fluid from the second compartment.

### CROSS REFERENCE TO RELATED APPLICATION

This application claims priority to U.S. Provisional Application No. 62/344,356, filed on Jun. 1, 2016, the entire contents of which are incorporated herein by reference.

### BACKGROUND OF THE INVENTION

### 1. Field of the Invention

The present invention relates to filtering systems, and in particular, to modular contaminant filtering system for rain water run-off, emergency spills, and isolated regular discharge flows.

### 2. Prior Art

Filtering systems capable of filtering contaminants in liquid run-off/discharge are bulky, complicated and expensive. Further, such filtering systems can require a team of maintenance workers for repair or replacement.

### SUMMARY OF THE INVENTION

Accordingly, a filter unit for filtering one or more of run-off fluid, chemical spills and facility discharge is provided. The filter unit comprising: a first compartment having: a volume capacity, an inlet for the one of run-off fluid, chemical spills and facility discharge, an outlet, and an overflow for discharging fluid flowing through the inlet when the volume capacity is full; and a second compartment having: one or more filters in fluid communication with the outlet of the first compartment for filtering the fluid in the first compartment that is not discharged through the overflow, and an outlet for discharging filtered fluid.

The inlet can be covered by a grate.

The overflow can be at a top of the volume capacity of the first compartment, the top being in a direction opposite to a direction of gravity.

The one or more filters can comprise a plurality of filters, each having a different filtering characteristic.

Also provided is a filter unit for filtering one or more of run-off fluid, chemical spills and facility discharge where the filter unit comprising: a plurality of first compartments, each having: a volume capacity, an inlet for the one of run-off fluid, chemical spills and facility discharge, an outlet, and an overflow for discharging fluid flowing through the inlet when the volume capacity is full; and a plurality of second compartments, each corresponding to a respective one of the plurality of first compartments, each of the second compartments having: one or more filters in fluid communication with the outlet of the respective one of the plurality of first compartments for filtering the fluid in the respective one of the plurality of first compartments that is not discharged through the overflow, and an outlet for discharging filtered fluid; wherein the overflow for each of the plurality of first compartments except for the last first compartment in the series is in communication with the inlet of a previous first compartment.

Still further provided is a method for filtering one or more of run-off fluid, chemical spills and facility discharge. The method comprising: storing a first portion of the one or more of run-off fluid, chemical spills and facility discharge in a first compartment; discharging additional fluid from an overflow in the first compartment when a volume capacity of the first compartment is full; in a second compartment in fluid communication with the first compartment, filtering the one or more of run-off fluid, chemical spills and facility discharge stored in the first compartment that is not discharged through the overflow, and discharging filtered fluid from the second compartment.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates a top view of a rain run-off inlet for a modular contaminant filtering unit.

FIG. 2 illustrates a cross-sectional view as taken along line A-A in FIG. 1 of the modular rain water run-off contaminant filtering system.

FIG. 3 illustrates a cross-sectional view as taken along line B-B in FIG. 1 of the modular rain water run-off contaminant filtering system.

FIG. 4 illustrates a modular initial run-off water storage and filtering unit construction.

FIG. 5 illustrates a modular filtering unit construction without overflow passages.

FIG. 6 illustrates a cross-sectional view of a filtering system for handling regularly discharged contaminated flows.

### DETAILED DESCRIPTION OF THE PREFERRED EMBODIMENT

A modular contaminant filtering system is disclosed herein that is suitable for many applications, in particular for filtering contaminants from rain water run-off in city streets, parks, river banks, coastal areas, and almost any other similar locations. The simple and adaptable design of the system and the modular and readily replaceable nature of its filtering units makes the system highly cost effective in terms of initial, running and maintenance costs. In this system, filtering “cartridge” units are readily replaced by a one-man crew or exchanged to handle fuel or other chemical spills in emergency situations. The basic design of the system lends itself also to use for filtering contaminated discharge from facilities such as small factories, food processing plants, larger cafeterias and restaurants, car washes, and the like that regularly discharge significant amounts of contaminated water into the environment.

The modular system is first described below for rain run-off filtering applications since it can provide a simple and low-cost method of eliminating most of its contaminants. The system can also be incorporated into the current street and park rain run-off inlets. The quick transformation of the system for emergency collection/filtering of spilled chemicals is then described, followed by its application to filtering nearly regular but relatively small flow of contaminated water discharged from relatively small service and production facilities.

When rain begins to fall over street or other similar surfaces, depending on its intensity and the level of accumulated contaminants over the surfaces, it would take a relatively short period of time until most contaminants are washed away. After such a period of time, the remaining rain water flows with minimal contaminant content. Thus, by filtering the initial flow of rain water run-off, most contaminants that have been accumulated over the affected surfaces can be removed. The amount of initial rain water flow to be filtered is dependent on the level and type of surface contaminants, the rain fall rate, surface area topology, among others factors.

In light of this concept, a novel contaminant filtering system for rain water run-off that can be readily implemented in city streets with minimal construction efforts is provided. The system, can include an added advantage of being fully modular, in the sense that the contaminant removing filtering units are readily replaceable and can be adapted to match the type of contaminants present in the run-off.

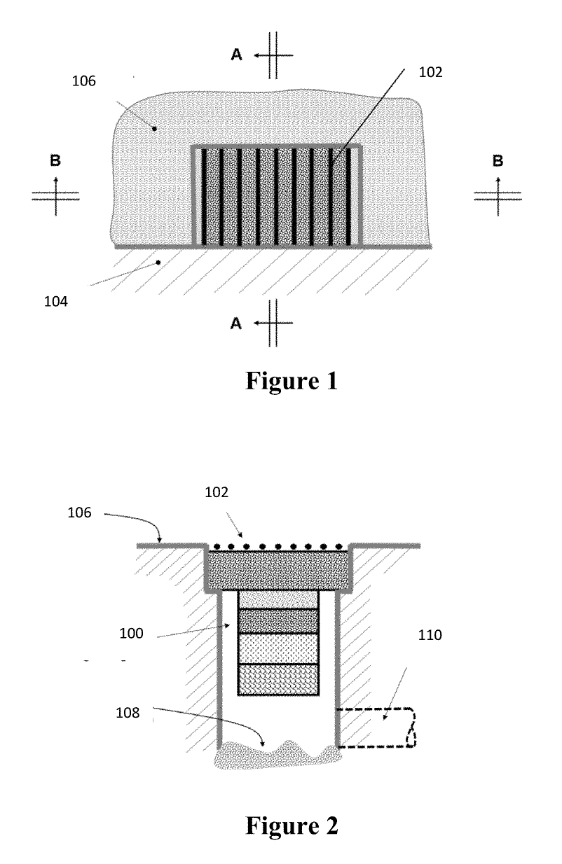

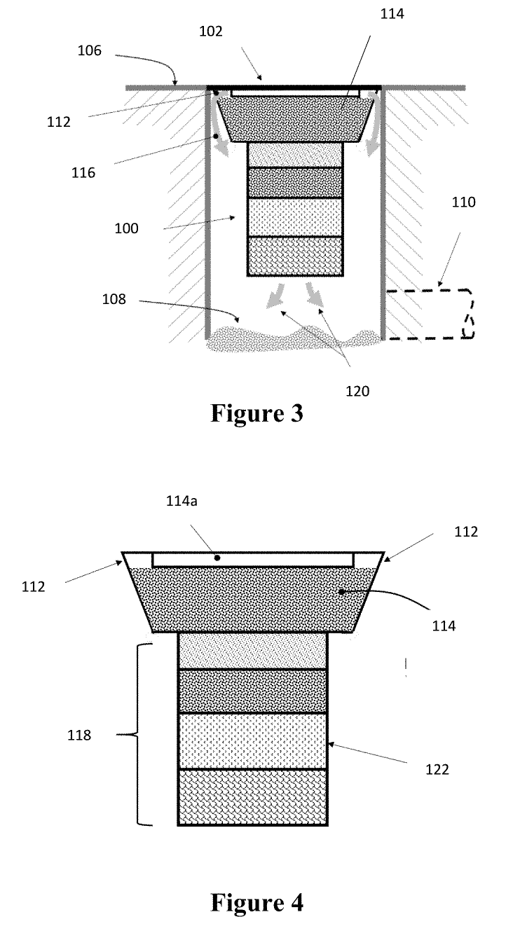

An embodiment and operation of a modular filtering system 100 is described below with reference to FIGS. 1-4. An existing rain water run-off inlet 102 at a curb 104 and at the street level 106 can be modified to adapt the present modular system. FIG. 1 shows a top view of the system. A commonly used rain run-off inlet cover 102 is shown to be used. The cross-sectional views A-A and B-B of the system as seen in the top view of FIG. 1 are shown in FIGS. 2 and 3, respectively. The readily replaceable “Modular initial run-off water storage and Filtering Unit” (MFU) is shown in FIG. 4. It is noted that when relatively large amounts of initial run-off water have to be filtered from relatively large surface areas, multiple MFUs may be provided to accommodate the filtering load.

As can be seen in the cross-sectional view A-A of FIG. 2, the modular filtering unit 100 is placed inside the provided space by removing the inlet cover 102. Lifting eyelets (not shown) can be provided on the modular filtering unit 100 structure so that it can be quickly attached to a lifting arm of a truck used for its quick replacement. To replace the modular filtering unit 100, the truck operator would attach the modular filtering unit 100 to the arm, lift it and place it over the truck bed. A clean modular filtering unit 100 would then be lowered in place with the same lifting arm. The process could not take as little as 4-5 minutes for each modular filtering unit 100. Each rain water run-off inlet 102 may be provided with several modular filtering units 100 depending on the size of the surface area to be serviced. A bottom surface of the space in which the modular filtering unit 100 is disposed can have gravel 108 and may have a pipe or outer conduit 110 to take away run-off processed by the modular filtering unit 100.

The cross-sectional view B-B from FIG. 1 is shown in FIG. 3. In this view, the modular filtering unit 100 includes overflow passages 112 provided on a top portion of the modular filtering unit 100. In operation, as the initial flow of rain water enters the modular filtering unit 100 though the top cover 102 of the inlet, it would first fill the indicated initial run-off storage container 114 and after that overflows through the provided overflow passages 112 at the top of the initial run-off storage container 114 and then into the provided space below (shown at 116), which may have been connected to a rain run-off collection system via the provided conduit 110. The initial run-off storage container 114 should be large enough to handle the required initial flow to achieve the desired level of contaminant removal capability or more than one modular filtering unit 100 may be employed.

Turning now to FIG. 4, the initial run-off storage container 114 can include an overflow fill region 114a corresponding to the overflow passages 112. The initial run-off storage container 114 can be at least partially filled with sand or other similar layers of different material, which can be used to filter larger solid contaminants. Whether fully filled or empty, the initial run-off storage container 114 can be capped with angled grids or similar means to prevent the run-off rain water from washing away the filling material or dilute the stored initial run-off water. The initial run-off water stored in the initial run-off storage container 114, which contains most of the washed-away contaminants, is then slowly filtered through one or more layers of filters 118 and discharged into the provided space below (shown at 120 in FIG. 3). The one or more layers of filters 118 can be rack mounted, such as on shelves, and individually replaceable so as to be customizable for a particular need.

The modular filtering unit 100 can be built with a structural frame 122 to accommodate several modular filtering layers 118 that can be packed into the lower compartment of the modular filtering unit 100 (the portion below the initial run-off container 114). The modular filtering unit 100 may be packed with different filtering layers 118 depending on the contaminants that are expected to be encountered. For example, with membranes to remove fuel residues, oil, fertilizer and other organic or heavy metals. The composition of the filtering layers 118 may be changed in minutes on-site or at the cleaning and re-stocking stations. The above described lifting eyelets can also be provided to the structural frame 122 to provide for a convenient way of lifting the entire modular filtering unit 100 above the street level 106 for east repair, replacement or reconfiguration of the filtering layers 118.

As discussed above, the modular filtering unit 100 disclosed above can be used to control spilled chemical removal. The construction of the modular filtering unit 100 can accommodate several filtering layers 118 as can be seen in the FIG. 4. The modular filtering unit 100 can be built with a structural frame 122 and shelf-like configuration to accommodate modular filtering layers 118 that are readily selected to adapt to the contaminating agents that are expected to be present in the run-off flow. As a result, the modular filtering unit 100 may be packed with different filtering layers 118 on-site by personnel handling hazardous material spilling conditions, such as fire department personnel. For example, filtering membranes may be quickly inserted into the modular filtering unit 100 to remove fuel residues, oil, fertilizer and other organic or heavy metals in a matter of minutes. In general, appropriate types of filtering layers 118 may also be stored, for example in fire stations, for quick insertion into the modular filtering unit 100 in case of such spills.

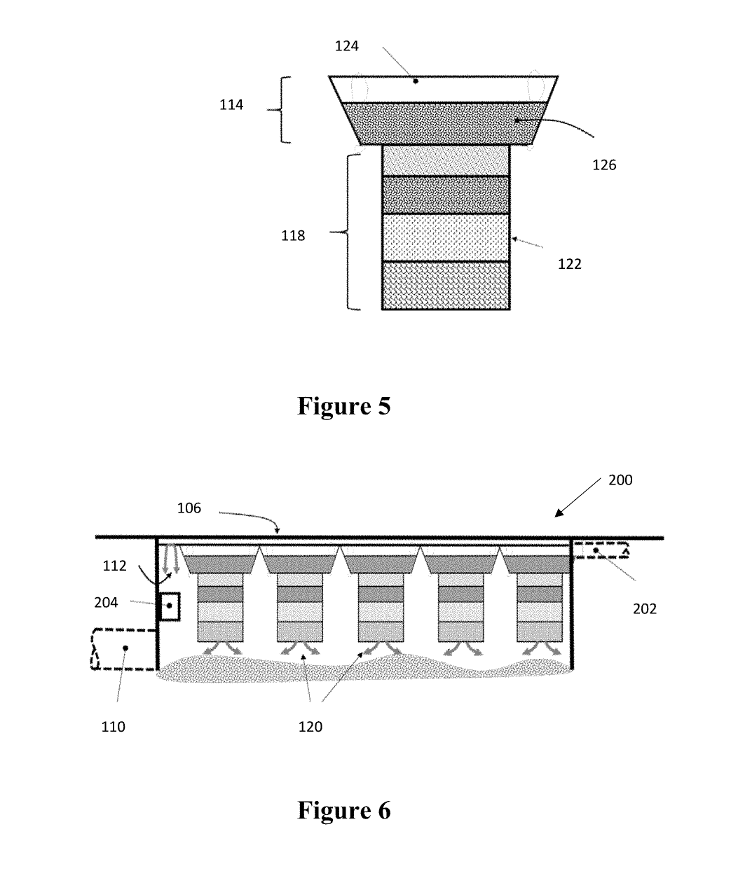

The modular filtering unit 100 disclosed herein can be readily adapted for filtering relatively small but regularly occurring discharges from facilities, such as small factories, food processing plants, larger cafeterias and restaurants, car washes, and other similar entities. In such applications, the modular filtering unit 100 may be installed with several in-series modular filtering units similar to the one shown in FIG. 4 to handle the peak flow, and be provided with filtering layers particularly selected for the contaminants present in the discharge. In these applications, the modular filtering unit 100 may be configured without the overflow passages of the modular filtering unit 100 of FIG. 4. A schematic of such a modular filtering unit 100 is shown in FIG. 5. In the configuration of FIG. 5, the initial run-off container 114 can be configured to have an empty portion 124 and a portion 126 filled with a pre-filtering material, such as large particle filtering sand.

A cross-sectional view of a modular filtering unit 200 installed to handle relatively small continuous or occasional discharges is shown in FIG. 6. In this configuration, the required number of modular filtering units 100 are positioned in-series along the path of the discharge flow to handle peak flow. The discharge flow channel may be covered as shown in FIG. 6 or may be open as shown in FIGS. 2 and 3. When closed, the discharge flow can be provided to the modular filtering unit 200 by an inlet conduit 202. The modular filtering unit 200 can also handle rain run-off water as discussed above and for such conditions, an end overflow discharge 112 can be provided. The overflow 112 would also handle cases of exceptionally high discharge rates that may occur.

As is shown in the schematic of FIG. 6, a flow activated sensor 204, such as a container with a float switch, can be provided to indicate the occurrence of an overflow event or blockage of the filter layers 118 (for example, by particulates being filtered). The container with float switch may be provided with small drainage holes such that once the overflow stops it is slowly emptied and readied to detect the next overflow. The float switch can be configured to output a notification, such as an alarm, to the facility that it is time to change the modular filtering units 100, unless the sensor 204 has been activated due to a heavy rain run-off flow. It is appreciated, however, that by providing a similar rain run-off detecting sensor 204 at a level above the discharge flow (not shown), the overflow due to rain run-off can be readily differentiated from that caused by the plant discharge flow.

In general, the modular filtering units 100 discussed above are useful for removal of contaminants collected on the surface of the ground (roadway, lawns, fields, etc), that are washed away by rain and flows into river, runoff collection and passages, etc. With such flow, the first few minutes will wash most of the contaminants, which are collected and slowly filtered by the modular filtering units 100 with a remainder of the flow overflowing from the modular filtering units 100. In this way, a very high percentage of the contaminants are extracted without the need for a large system.

Furthermore, with the use of a layered modular filtering system, the filters can be replaced regularly or cleaned and reused. The number of modular filtering units can be selected to match the area to be served and the expected volume of initial runoff to be filtered to achieve the desired level of contaminant removal.

The filter units 100 may serve as storage tanks for the collected initial runoff rain, etc., or separate tanks for storing the initial runoff rain may be provided. The latter can be provided with flaps that close the passage into the tank and allow the following runoff rain to overflow and run into runoff collection pipes, etc. In the former case, the top layer can be made to allow the initial runoff rain in until it cannot accommodate any more liquid and the remainder is overflown into collection pipes for removal. The top surface layer can be resistant to overflow water at its highest rate.

In the case of spillage of certain materials (solid or liquid), appropriate filter modules can be used to replace the normally used filters—or empty containers can be used to collect wash-off water, etc., used to clean up the contaminants. The empty modules may be used together with pumps to drain the module continuously or at different intervals and transfer into tankers or the like for removal.

A special delivery/removal truck can be used to automatically engage the modules and place it onto the truck and replace it with a clean filter.

The filter units 100 may be layered—with each layer being readily replaceable so that:

a. Only the contaminated layers may be replaced during the cleaning process; and

b. A desired combination of filter layers can be used depending on the season, for example to take out sand and salt during the winter months, or in the case of certain hazardous material spillage or the like;

Certain filter units 100 may be provided with internal pumping means or means of attaching a pumping connection to increase the rate of filtering.

The output of the filter unit 100 can be discharged into the rain water runoff pipes when present or into the storage volume for permeation into the ground below.

The filter unit 100 can be accessed directly from the ground surface after removing a top grid 102 or porous block or the like that allows unhindered flow of water into the filter unit 100. The grid 102 may be an integral part of the module, thereby eliminating the need to remove a first capping member to access the filter unit 100.

Alternatively—in particular in a plant yard or banks of a road, a channel may be provided in which provisions are made to drop in the required number of filter units 100 in the path of the flow of the runoff rain (or surface cleaning) water. The filter units 100 would then collect and slowly filter the predetermined amount of initial runoff water that is needed to filter the desired percentage of contaminants that is expected to be present on the surface of the road or lawn, etc.

When used to filter a continuously discharged contaminated water, for example from a plant, enough filter units 100 can be placed along the passage (e.g., provided channel) to allow the entire discharge to be continuously discharged. The filter units 100 can then be periodically replaced as the filtering rate (throughput) is reduced. The throughput reduction can be readily observed (detected) when the flow moves farther downstream than a threshold distance. At this time the oldest filter units 100 can be replaced until the desired throughput is achieved. The filter unit 100 housings can be provided with locking flaps or the like that prevent from after the filter unit 100 has been pulled out a certain distance. Alternatively, a lever can be provided that is used to close the outlet from the filter unit 100 housing before the filter unit 100 is removed and is opened after its replacement.

The filter unit 100 can be configured such that the inflow goes through a sediment separation section and then flow into the filter layers 118.

The storage portion 114 and filtering layers 118 may be provided in two separate pieces and each replaced as needed.

Filtering layers 118 can be stored in fire departments or the like for on-site replacement in the case of fuel or other chemical spills.

For regular discharge from different facilities such as small factories, food processing plants, fish markets, restaurants, etc., more than one can be placed in-series and/or in-parallel to accommodate the discharge (mostly occurring slowly or once in a while). Such units can be provided with end overflow passage, FIG. 6, for sudden surge that cannot be handled or rain run-off that may overwhelm the system. The end overflow sensor 204 (e.g., bucket with float switch) can be used to alert the user that overflow has occurred or that MFUs have to be replaced. A similar bucket sensor (not shown) can be placed above the inlet level to collect rain run-off to allow the monitoring system to differentiate overflow events occurred due to the rain from those occurring due to the discharge overflow.

The filter units 100 can be provided with eyelets for attachment to a lifting arm on a truck used to remove and replace or install a filter unit 100. The rain run-off inlet cover 102 may be integral to the filter unit 100 and may be used in place of the eyelets.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A filter unit for filtering one or more of run-off fluid, chemical spills and facility discharge, the filter unit comprising:
a first compartment having:
a volume capacity,
an inlet for the one of run-off fluid, chemical spills and facility discharge,
an outlet, and
an overflow for discharging fluid flowing through the inlet when the volume capacity is full; and
a second compartment having:
one or more filters in fluid communication with the outlet of the first compartment for filtering the fluid in the first compartment that is not discharged through the overflow, and
an outlet for discharging filtered fluid.

2. The filter unit of claim 1, wherein the inlet is covered by a grate.

3. The filter unit of claim 1, wherein the overflow is at a top of the volume capacity of the first compartment, the top being in a direction opposite to a direction of gravity.

4. The filter unit of claim 1, wherein the one or more filters comprise a plurality of filters, each having a different filtering characteristic.

5. A filter unit for filtering one or more of run-off fluid, chemical spills and facility discharge, the filter unit comprising:
a plurality of first compartments, each having:
a volume capacity,
an inlet for the one of run-off fluid, chemical spills and facility discharge,
an outlet, and
an overflow for discharging fluid flowing through the inlet when the volume capacity is full; and
a plurality of second compartments, each corresponding to a respective one of the plurality of first compartments, each of the second compartments having:
one or more filters in fluid communication with the outlet of the respective one of the plurality of first compartments for filtering the fluid in the respective one of the plurality of first compartments that is not discharged through the overflow, and
an outlet for discharging filtered fluid;
wherein the overflow for each of the plurality of first compartments except for the last first compartment in the series is in communication with the inlet of a previous first compartment.

6. A method for filtering one or more of run-off fluid, chemical spills and facility discharge, the method comprising:
storing a first portion of the one or more of run-off fluid, chemical spills and facility discharge in a first compartment;
discharging additional fluid from an overflow in the first compartment when a volume capacity of the first compartment is full;
in a second compartment in fluid communication with the first compartment, filtering the one or more of run-off fluid, chemical spills and facility discharge stored in the first compartment that is not discharged through the overflow, and
discharging filtered fluid from the second compartment.
